(19) United States
(12) Patent Application Publication
(10) Pub. No.: US 2021/0339315 A1
(43) Pub. Date: Nov. 4, 2021

(54) Method for Producing Metal Particle Composition, and Metal Particle Composition

(71) Applicant: Sumitomo Chemical Company, Limited, Tokyo (JP)

(72) Inventors: Takuya Matsunaga, Ibaraki (JP); Satsohi Shimano, Ibaraki (JP)

(73) Assignee: Sumitomo Chemical Company, Limited, Tokyo (JP)

(21) Appl. No.: 17/282,194

(22) PCT Filed: Sep. 30, 2019
(86) PCT No.: PCT/JP2019/038616

§ 371 Date: Apr. 1, 2021

(30) Foreign Application Priority Data
Oct. 5, 2018 (JP) 2018-189769

(51) Int. Cl. B22F 9/04; B22F 1/00

(52) U.S. Cl. CPC B22F 9/04; B22F 2304/10; B22F 1/0011

(57) ABSTRACT

The problem of the invention is to provide a method for producing a metal particle composition that can obtain metal material particles having a narrow particle size distribution in a metal material having a lower hardness than silicon. The means for solving the problem is a method for producing a metal particle composition containing particles of a metal material, a component derived from a pulverizing container, and a component derived from beads, the method comprising a step of pulverizing with stirring the metal material containing a metal simple substance having a Mohs hardness of 2.5 to 6.3 in the pulverizing container in the presence of the beads that serve as pulverizing media using a media-stirring type pulverizer equipped with a rotating body,

wherein the mass ratio of the metal material to the beads is 0.02 to 0.10 and
wherein the rotating body has a peripheral speed of 2.5 to 8.5 m/s.

### CROSS-REFERENCE TO RELATED APPLICATION

This application claims benefit under Article 4 of the Paris Convention based on Japanese Patent Application No. 2018-189769 filed in Japan on Oct. 5, 2018, incorporated herein by reference in its entirety.

### TECHNICAL FIELD

The present invention relates to a method for producing a metal particle composition and a metal particle composition useful as a negative electrode material for lithium ion secondary batteries.

### BACKGROUND ART

Group 14 elements silicon, germanium, and tin have a larger capability of occluding lithium ions than carbon-based materials, and are therefore useful as a negative electrode material for lithium ion secondary batteries. For example, when germanium is used as a negative electrode active material for lithium ion secondary batteries, a discharge capacity four times or more that of a carbon-based negative electrode active material is provided (Patent Document 1).

However, the volume of metal materials such as silicon and germanium expands greatly accompanying the occlusion of lithium ions. Therefore, a large stress is generated in a negative electrode active material layer during charging, cracks and peeling occur in the negative electrode active material layer, and the resistance is increased, resulting in the deterioration of the charge/discharge characteristics.

When metal particles of a silicon-based metal material are used as a negative electrode material for lithium ion secondary batteries, it is known that the charge/discharge reaction of lithium ions can be made uniform by making crystallites of silicon smaller by microparticulation or micronization of a silicon alloy, or by making it amorphous, the expansion and contraction of the volume due to the repeated charge/discharge reaction can be made uniform, and as a result, the repetition lifetime is also extended (Patent Document 2).

Further, for metal particles of the silicon-based metal material, a method is known for obtaining nanometer-sized metal particles by a pulverization method including a dry pulverization step and a wet pulverization step using a silicon oxide as a material is kn wn (Patent Document 3).

### PRIOR ART DOCUMENTS

### Non-Patent Document

Patent Document 1: JP 2012-33371 A
Patent Document 2: JP 2010-135336 A
Patent Document 3: JP 2014-534142 A

### SUMMARY OF THE INVENTION

### Problem to be Solved by the Invention

However, in the metal material having a lower hardness than silicon, even if its microparticulation is attempted by a similar pulverization method to that of a silicon-based metal material, the particle size distribution of the metal particles is rather broadened, so that there is a problem that microparticulation or micronization is difficult.

The present invention solves the above the problem, and it is an object of the present invention to provide a pulverization method that can obtain metal material particles having a narrow particle size distribution in a metal material having a lower hardness than silicon. It is also an object of the present invention to provide a metal particle composition having a large discharge capacity, excellent coating characteristics, and excellent capacity retention performance before and after high-speed discharge when used as a negative electrode material for lithium ion secondary batteries and the like.

### Means for Solving the Problem

That is, the present invention provides a method for producing a metal particle composition containing particles of a metal material, a component derived from a pulverizing container, and a component derived from beads, the method comprising a step of pulverizing with stirring the metal material containing a metal simple substance having a Mohs hardness of 2.5 to 6.3 in the pulverizing container in the presence of the beads that serve as pulverizing media using a media-stirring type pulverizer equipped with a rotating body, wherein the mass ratio of the metal material to the beads is 0.02 to 0.10, and wherein the rotating body has a peripheral speed of 2.5 to 8.5 m/s.

In one embodiment, the media-stirring type pulverizer is a media-stirring type mill equipped with a pulverizing container and a stirring blade.

In one embodiment, the metal material is at least one germanium material selected from the group consisting of germanium and germanium alloys.

In one embodiment, a dispersion medium is used in the step of pulverizing the metal material.

In one embodiment, the mass ratio of the metal material to the dispersion medium is 0.07 to 0.5.

In one embodiment, the beads have a diameter of 0.03 mm to 2 mm.

In one embodiment, the material of the pulverizing container includes alumina, and the material of the beads includes zirconia.

In one embodiment, the metal particle composition has a maximum particle diameter (D₁₀₀) of 0.2 to 5.2 μm in a volume-based particle size distribution.

In one embodiment, the metal particle composition contains at least one of zirconium and aluminum, and the total amount of zirconium and aluminum is 0.028 to 1.0 parts by weight with respect to 100 parts by weight of the metal particles.

Also, the present invention provides a metal particle composition containing metal particles of a metal material containing a metal simple substance having a Mohs hardness of 2.5 to 6.3, and at least one of zirconium and aluminum,

wherein the metal particles have a maximum particle diameter (D₁₀₀) of 0.2 to 5.2 μm in a volume-based particle size distribution, and
wherein the total amount of the zirconium and aluminum is 0.028 to 1.0 parts by weight with respect to 100 parts by weight of the metal particles.

In one embodiment, the total amount of zirconium and aluminum is 0.028 to 0.146 parts by weight with respect to 100 parts by weight of the metal particles.

In one embodiment, the metal material is at least one germanium material selected from the group consisting of germanium and germanium alloys.

Also, the present invention provides a method for producing a metal particle composition containing particles of a metal material, a component derived from a pulverizing container, and a component derived from beads, the method comprising:

a first pulverizing step of pulverizing with stirring the metal material containing a metal simple substance having a Mohs hardness of 2.5 to 6.3 in the pulverizing container in the presence of the beads (1) that serve as pulverizing media using a media-stirring type pulverizer equipped with a rotating body,

wherein the mass ratio of the metal material to the beads (1) is 0.02 to 0.10, and
wherein the rotating body has a peripheral speed of 2.5 to 8.5 m/s;

a step of separating the resulting metal particle composition (1) from the beads (1); and

a second pulverizing step of stirring and pulverizing the metal particle composition (1) in the pulverizing container in the presence of beads (2) that serve as pulverizing media using the media-stirring type pulverizer equipped with the rotating body,

wherein the mass ratio of the metal material (1) to the beads (2) is 0.02 to 0.10, and
wherein the rotating body has a peripheral speed of 2.5 to 8.5 m/s.

In one embodiment, the beads (1) have an average particle diameter of 0.2 to 2 mm, the beads (2) have an average particle diameter of 0.03 to 0.2 mm, and the beads (1) have a larger average particle diameter than the beads (2).

Also, the present invention provides a metal particle composition obtained by any of the above methods.

### Effect of the Invention

According to the present invention, a method for producing a metal particle composition that can obtain metal material particles having a narrow particle size distribution in a metal material having a lower hardness than silicon is provided. Also, according to the present invention, a metal particle composition having a large discharge capacity, excellent coating characteristics, and excellent capacity retention performance before and after high-speed discharge when used as a negative electrode material for lithium ion secondary batteries and the like is provided.

### BRIEF DESCRIPTION OF THE DRAWINGS

FIG. 1 is a schematic cross-sectional view of a bead milling apparatus.

FIG. 2 is a particle size distribution diagram of metal particles of Example 1.

FIG. 3 is a scanning electron microscope image of the metal particles of Example 1.

FIG. 4 is a particle size distribution diagram of metal particles of Comparative Example 1.

FIG. 5 is a scanning electron microscope image of the metal particles of Comparative Example 1.

FIG. 6 is a particle size distribution diagram showing changes over time of the metal particles of Example 1.

FIG. 7 is a particle size distribution diagram showing changes over time of the metal particles of Comparative Example 1.

FIG. 8 is a scanning electron microscope image of the metal particles of Comparative Example 1 when the pulverizing time was 60 minutes.

FIG. 9 is a scanning electron microscope image of the metal particles of Comparative Example 1 when the pulverizing time was 75 minutes.

FIG. 10 is a scanning electron microscope image of the metal particles of Comparative Example 1 when the pulverizing time was 90 minutes.

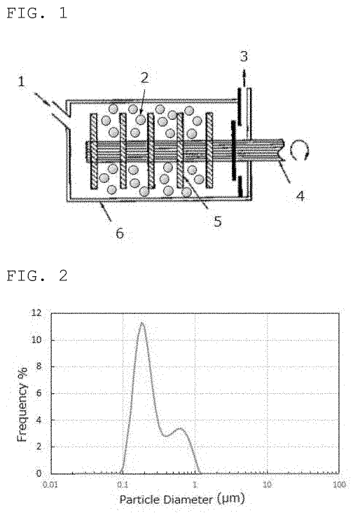

### DETAILED DESCRIPTION OF THE PREFERRED EMBODIMENTS

As used herein, the term “Mohs hardness” is an empirical measure for determining the hardness of a mineral by comparing it with ten reference minerals. The reference minerals from soft (Mohs hardness 1) to hard (Mohs hardness 10) are talc, gypsum, calcite, fluorite, apatite, orthoclase, quartz, topaz, corundum and diamond. Rubbing a sample material for which one wants to know the hardness against reference minerals and measuring the hardness based on the presence or absence of scratches. For example, if it is not scratched with fluorite, and scratched with apatite, the Mohs hardness is 4.5 (meaning between 4 and 5).

As used herein, the “average particle diameter” is a value of the volume average particle diameter measured using a laser analysis method.

<Method for Producing Metal Particles>

The present invention relates to a method for producing metal particles.

The method of the present invention is a method for producing metal particles, comprising a step of pulverizing a metal material containing a metal simple substance having a Mohs hardness of 2.5 to 6.3 by beads using a media-stirring type pulverizer equipped with a pulverizing container and a rotating body, wherein the ratio of the mass of the metal material to the mass of the beads is 0.02 to 0.10, and wherein the rotating body has a peripheral speed of 2.5 to 8.5 m/s.

In the step of pulverizing the metal material (hereinafter referred to as the “pulverizing step”), the metal material is stirred in the pulverizing container in the presence of the beads that serve as pulverizing media, and the beads and the pulverizing container collide and rub with each other. At the time, both the materials may be worn away depending on the type of material used for the beads and the pulverizing container. As a result, materials constituting the beads and the pulverizing container are mixed into the metal particles that serve as the object to be pulverized. When the materials mixed during the pulverization are considered as components of the pulverized product, the pulverized metal particles have the same meaning as the metal particle composition containing the particles of the metal material, the component derived from the pulverizing container, and the component derived from the beads. In such a case, the present invention, which is a method for producing metal particles, has the same meaning as the method for producing a metal particle composition.

<Metal Material>

In the method of the present invention, a metal material containing at least one metal simple substancehaving a Mohs hardness of 2.5 to 6.3 is used as the object to be pulverized.

The metal simple substance having a Mohs hardness of 2.5 to 6.3 includes Ti (Mohs hardness: 6. Hereinafter similarly, the numerical values in parentheses indicate the Mohs hardness.), Mn (6), Ge (6), Nb (6), Rh (6), U (6), Be (5.5), Mo (5.5), Hf (5.5), Co (5), Zr (5), Pd (4.75), Fe (4), Ni (4), As (3.5), Pt (3.5), Cu (3), Sb (3), Th (3), A1 (2.75), Mg (2.5), Zn (2.5), Ag (2.5), La (2.5), Ce (2.5), Au (2.5) and the like. Here, G. V. Samsonov, ed., “Mecanical Properties of the Element” Handbook of the physicochemical properties of the elements, New York, USA: IFI-Plenum. (1968) was cited as a source.

If the Mohs hardness of the metal simple substance contained in the metal material is too high, the pulverization time required for microparticulation may be longer. On the other hand, if the Mohs hardness is too low, elongation and agglomeration of the metal particles are liable to occur accompanying the pulverization, and their microparticulation by pulverization is sometimes difficult.

The Mohs hardness of the metal simple substance contained in the metal material is preferably 3 to 6.3, more preferably 4 to 6.3, and even more preferably 5 to 6.3.

The metal material is a metal material containing at least one elementary metal selected from Ti, Mn, Ge, Nb, Rh, U, Be, Mo, Hf, Co, Zr, Pd, Fe, Ni, As, Pt, Cu, Sb, Th, Al, Mg, Zn, Ag, La, Ce and Au, preferably a metal material containing at least one elementary metal selected from Ge, Ti, Mn, Nb, Mo, Co and Zr, more preferably a metal material containing Ge, and preferably a germanium material selected from the group consisting of germanium and germanium alloys.

The metal material may be a metal simple substance having a Mohs hardness of 2.5 to 6.3, or an alloy containing at least one metal simple substance having a Mohs hardness of 2.5 to 6.3.

When the metal material is an alloy, containing a metal simple substance having a Mohs hardness of 2.5 to 6.3 means that a metal element constituting the metal simple substance is contained in the alloy. The proportion of the metal element is preferably 10% by mass or more, more preferably 50% by mass or more, further preferably 75% by mass or more, and particularly preferably 90% by mass or more.

Two or more kinds of metal materials may be used. The metal material may be a material in which two or more kinds of metal simple substances having a Mohs hardness of 2.5 to 6.3 are mixed, or a material in which two or more kinds of alloys containing at least one metal simple substance having a Mohs hardness of 2.5 to 6.3 are mixed, or a material in which the at least one metal simple substance and the at least one alloy are mixed.

The metal material contains a metal with a Mohs hardness of 2.5 to 6.3 as a metal simple substance. The Mohs hardness of the metal simple substance is preferably 3 to 6.3, more preferably 4 to 6.3, and even more preferably 5 to 6.3. If the Mohs hardness of the metal simple substance of the metal contained in the metal material is less than 2.5, elongation and agglomeration of the metal particles are liable to occur accompanying the pulverization, and microparticulation is sometimes difficult by the pulverization. If it exceeds 6.3, the pulverizing time required for the microparticulation may be longer.

In the method of the present invention, the material to be put into the pulverizing container may include other materials other than the metal material. Other materials include boron, boride, graphite, glassy carbon, carbon nanotubes, graphene, fullerene, amorphous carbon, carbon fiber, carbon black, diamond, carbides, nitrides, nitrites, nitrates, phosphorus, phosphides, phosphates, oxides, sulfur, sulfides, sulfites, sulfates, selenium, selenides, tellurium, tellurides, tellurates, fluorides, chlorides, bromides, and iodides. The ratio of the other materials to the sum of the metal material and the other materials is preferably 0 to 50% by mass, more preferably 0 to 25% by mass, even more preferably 0 to 10% by mass, and particularly preferably 0 to 5% by mass.

The metal material is pulverized using beads. For example, the metal material and beads are charged in a pulverizing container, and, by rotational movement of the rotating body, the metal material and the beads in the pulverizing container flow, and the beads and the metal material collide with each other, thus making it possible to pulverize the metal material.

<Pulverizing Step>

The pulverizing step is a step of pulverizing the metal material with beads by using a media-stirring type pulverizer provided with a pulverizing container and a rotating body in the presence of the metal material. In the pulverizing step, it is preferable that the metal material is pulverized in the presence of a dispersion medium. In a region where the particle diameter of the metal material is 1 μm or less, by using the dispersion medium, the surface of the metal material is wetted to weaken the interaction between particles, so that the agglomeration of metal materials is suppressed. In addition, it is possible to suppress adherence of the metal materials to the pulverizing container, beads or rotating body.

The media-stirring type pulverizer includes a dry pulverizing apparatus that pulverizes a metal material only with beads without using a dispersion medium, and a wet pulverizing apparatus that pulverizes a metal material using a dispersion medium and beads.

The dry pulverizing apparatus includes a rotary cylinder ball mill that rotates and/or revolves the pulverizing container itself to make the metal material and beads that are the contents flow and the like.

The wet pulverizing apparatus includes a rotary cylinder ball mill that rotates and/or revolves the pulverizing container itself to make the metal material, dispersion medium, and beads that are the contents flow, a media-stirring type mill having a stirring blade consisting of a shaft and arms inside the pulverizing container, and rotating the shaft to make the metal material, dispersion medium, and beads that are the contents flow by the arms, and the like. The media-stirring type mill is preferable from the viewpoint that pulverization is completed in a short time by efficiently transferring the mechanical energy due to rotation to the contents. Examples of the media-stirring type mill include a bead mill, an attritor and the like.

In the media-stirring type mill, there are a batch type in which pulverization is performed in a state in which a certain amount of contents is stored in a pulverizing container, and a circulation type in which a metal material dispersed in a dispersion medium is circulated and made to flow inside and outside the pulverizing container. In particular, the circulation type media-stirring type mill is industrially advantageous because it can homogeneously process a large amount of a metal material in a short time.

In the present specification, the rotating body is a part that directly transmits kinetic energy to beads by rotational movement. The rotating body in the media-stirring type mill such as a bead mill or an attritor is a stirring blade consisting of a shaft and arms. The rotating body in the rotary cylinder ball mill that rotates and/or revolves a pulverizing container itself such as a ball mill to make the metal material and beads that are the contents flow is a pulverizing container. In one embodiment of the invention, the rotating body is a stirring blade.

A surface of the pulverizing container brought into contact with the metal material may be formed of a material having a strength not to be damaged during the pulverizing step. The material of the pulverizing container includes alumina or zirconia, and also includes another element oxide-toughened alumina or another element oxide-stabilized zirconia, in which the alumina or the zirconia is mixed with another element. In the case of another element oxide-toughened alumina, zirconium is used as another element. In the case of another oxide-stabilized zirconia, aluminum, yttrium, calcium, magnesium, hafnium and the like are used as another element.

Using the pulverizing container body made of alumina is preferred because it becomes easy to obtain a metal particle composition which can provide a large discharge capacity, excellent coating characteristics, and excellent capacity retention performance before and after high-speed discharge when it is used as a negative electrode material for lithium ion secondary batteries and the like. The pulverizing container body made of alumina includes a pulverizing container body made of alumina.

Beads are pulverizing media for pulverizing the metal material. The diameter of the beads is an average particle diameter of the beads. When the average particle diameter of the beads is large, the pulverizing media are sometimes referred to as balls, but in the present specification, the solid pulverizing media are referred to as beads regardless of the average particle diameter of the beads. The beads flow at a high speed in the pulverizing container due to the rotation of the pulverizing container itself of the pulverizer or the rotation of the shaft with the arms and the like, and collide with the metal material so as to crush it into metal materials with a smaller average particle diameter. In the pulverizing step, it is preferable that the pulverizing container and the beads are not excessively worn away. Therefore, the shape of the beads is preferably spherical or ellipsoidal.

The diameter of the beads is preferably larger than the average particle diameter of metal particles after pulverization. By using such beads, a great pulverizing energy can be imparted to the metal material, thus making it possible to obtain metal particles efficiently in a short time. On the other hand, if the diameter of the beads is too large, re-agglomeration of metal particles is facilitated, and metal particles having a broad particle size distribution are produced.

The diameter of the beads is preferably 0.03 mm to 2 mm, more preferably 0.05 mm to 1 mm, and even more preferably 0.1 mm to 0.8 mm. When the diameter of the beads is in this range, re-agglomeration of metal particles can be suppressed, and metal particles having a narrow particle size distribution can be efficiently obtained in a short time.

The diameter of the beads put in the pulverizing container may be uniform or different.

The material of the beads includes glass, agate, alumina, zirconia, stainless steel, chrome steel, tungsten carbide, silicon carbide, and silicon nitride. Among them, zirconia is preferably used because it has a relatively high hardness, and is not easily worn away, and also because it has a relatively large specific gravity, and a large pulverizing energy can be obtained. By using these beads, the metal material can be efficiently pulverized.

Using the pulverizing media made of zirconia is preferred because it becomes easy to obtain a metal particle composition which can provide a large discharge capacity, excellent coating characteristics, and excellent capacity retention performance before and after high-speed discharge when it is used as a negative electrode material for lithium ion secondary batteries and the like.

Also, using the pulverizing media made of zirconia and using the pulverizing container body made of alumina are further preferred because it becomes easy to obtain a metal particle composition which can provide a large discharge capacity, excellent coating characteristics, and excellent capacity retention performance before and after high-speed discharge when it is used as a negative electrode material for lithium ion secondary batteries and the like.

The pulverizing step is performed, for example, with the ratio of the mass of the metal material to the mass of the beads set to 0.02 to 0.10. The ratio of the mass of the metal material to the mass of the beads is preferably 0.02 to 0.09, and more preferably 0.02 to 0.06. When the ratio of the mass of the metal material to the mass of the beads is in this range, re-agglomeration of metal particles is facilitated, and metal particles having a narrow particle size distribution are obtained.

In the circulation type media-stirring type mill, the ratio of the mass of the metal material to the mass of the beads in the pulverizing container is calculated by using the mass of the metal material in the pulverizing container during a steady state of operation of the apparatus. The mass of the metal material in the pulverizing container can be calculated using the following formula.

$${W}_{M , V} = {W}_{M , T} \times \frac{( {V}_{C} - {V}_{B} )}{( {V}_{DM , T} + {V}_{M , T} + {V}_{NM , T} )} = {W}_{M , T} \times \frac{( {V}_{C} - {W}_{B} / {ρ}_{B} )}{( {W}_{DM , T} / {ρ}_{DM , T} + {W}_{M , T} / {ρ}_{M , T} + {W}_{NM , T} / {ρ}_{NM , T} )} \qquad [ Numerical Formula 1 ]$$

Where the respective symbols are W_{M,V}: mass of metal material in pulverizing container, V_{C}: effective volume of pulverizing container, V_{M,T}: volume of circulating metal material, W_{M,T}: mass of circulating metal material, ρ_{M,T}: density of metal material, V_{B}: volume of beads, W_{B}: mass of beads, ρ_{B}: true density of beads, V_{DM,T}: volume of circulating dispersion medium, W_{DM,T}: mass of circulating dispersion medium, ρ_{DM,T}: density of dispersion medium, V_{NM,T}: volume of materials other than circulating metal, W_{NM,T}: mass of materials other than circulating metal, ρ_{NM,T}: density of materials other than metal.

The pulverizing step is preferably performed at a peripheral speed of the rotating body of 2.5 to 8.5 m/s. The peripheral speed of the rotating body is a maximum rotational movement of the rotating body. The peripheral speed in the media-stirring type mill such as a bead mill or an attritor is a maximum speed of the stirring blade that is the rotating body during a steady operation, and more specifically means a peripheral speed of the outermost circumference of the stirring blade having the longest diameter.

The peripheral speed in the rotary cylinder ball mill is a maximum rotational speed of the pulverizing container itself that is the rotating body during steady operation, and more specifically, a peripheral speed of an inner wall of the pulverizing container imparted by rotation and/or revolution.

The peripheral speed of the rotating body is preferably 3 to 8 m/s. When the peripheral speed of the rotating body is in this range, re-agglomeration of metal particles is facilitated, and metal particles having a narrow particle size distribution are obtained.

The filling ratio of the beads is preferably 10% by volume or more and 74% by volume or less of the volume of the pulverizing container included in the media-stirring type pulverizer.

Further, after the pulverizing step is completed, the beads are separated from the metal particles and the solvent by using a filter or the like.

Water or an organic solvent may be used as the dispersion medium. The organic solvent may optionally contain water. The organic solvent includes alcohol based solvents, ether based solvents, ketone based solvents, glycol based solvents, hydrocarbon based solvents, and aprotonic polar solvents. Among these, alcohol based solvents are preferable from the viewpoint that they hardly oxidize the metal material and that metal particles having a narrow particle size distribution can be obtained.

Alcohol-based solvents include methanol (MeOH), ethanol (EtOH), n-propyl alcohol, isopropyl alcohol (IPA), n-butyl alcohol, isobutyl alcohol, sec-butyl alcohol, t-butyl alcohol, heptanol, n-amyl alcohol, sec-amyl alcohol, n-hexyl alcohol, tetrahydrofurfuryl alcohol, furfuryl alcohol, allyl alcohol, ethylenechlorohydrin, octyldodecanol, 1-ethyl-1-propanol, 2-methyl-1-butanol, isoamyl alcohol, t-amyl alcohol, sec-isoamyl alcohol, neoamyl alcohol, hexyl alcohol, 2-methyl-1-pentanol, 4-methyl-2-pentanol, heptyl alcohol, n-octyl alcohol, 2-ethylhexyl alcohol, nonyl alcohol, decyl alcohol, undecyl alcohol, lauryl alcohol, cyclopentanol, cyclohexanol, benzyl alcohol, α-terpineol, terpineol C, L-α-terpineol, dihydroterpineol, tarpinyloxyethanol, dihydroterpinyloxy ethanol and the like.

Glycol-based solvents include ethylene glycol, diethylene glycol, triethylene glycol, propylene glycol, dipropylene glycol, 1,3-butylene glycol, hexylene glycol, polyethylene glycol, polypropylene glycol and the like.

Ether-based solvents include ether based ones such as ethyl ether, isopropyl ether, dioxane, tetrahydrofuran, dibutyl ether, butyl ethyl ether, methyl-t-butyl ether, turpinyl methyl ether, dihydroterpinyl methyl ether, diglime, and 1,3-dioxolane, and dialkyl ether based ones such as diethylene glycol dimethyl ether, diethylene glycol diethyl ether, diethylene glycol methyl isobutyl ether, dipropylene glycol dimethyl ether and dipropylene glycol diethyl ether.

Ketone-based solvents include acetone, methyl ethyl ketone (MEK), diethyl ketone, methyl propyl ketone, methyl isobutyl ketone, methyl amyl ketone, cyclohexanone, cyclopentanone and the like.

Hydrocarbon-based solvents include aromatic hydrocarbon based ones such as toluene and xylene, hydrocarbon based ones such as n-hexane, cyclohexane and n-heptane, and halogenated hydrocarbon based ones such as methylene chloride, chloroform and dichloroethane.

Aprotic polar based solvents include dimethylformamide, dimethylacetamide, dimethyl sulfoxide, acetonitrile, and N-methyl-2-pyrrolidone (NMP).

Among these, isopropyl alcohol, ethanol, and water are preferable from the viewpoint that metal particles having a narrow particle size distribution can be obtained, and isopropyl alcohol is more preferable.

The organic solvents may be optionally mixed and used as a dispersion medium. Further, the dispersion medium may contain a surfactant. The surfactant includes organic compounds having a carboxyl group, organic compounds having a thiol group, organic compounds having a phenol ring, anionic surfactants, cationic surfactants, amphoteric surfactants, and nonionic surfactants.

Organic compounds having a carboxyl group include saturated and unsaturated carboxylic acids having 1 to 20 carbon atoms such as formic acid, acetic acid, propionic acid, butanoic acid, hexanoic acid, heptanic acid, octanoic acid, nonanoic acid, decanoic acid, undecanoic acid, lauric acid, myristic acid, palmitic acid, stearic acid, and oleic acid, linoleic acid, and linolenic acid, in addition to these, hydroxycarboxylic acids, alicyclic groups having 6 to 34 carbon atoms, aromatic carboxylic acids and the like.

Organic compounds having a thiol group include alkanethiols such as mercaptoethanol, mercapto-2-propanol, 1-mercapto-2,3-propanediol, 3-mercaptopropyltrimethoxysilane, mercaptosuccinic acid, hexanethiol, pentanedithiol, dodecanethiol, undecanethiol and decanethiol and the like.

Organic compounds having a phenol ring include triphenylphosphine, tributylphosphine, trioctylphosphine, tributylphosphine and the like.

Anionic surfactants include higher fatty acid salts, alkyl sulfonates, alpha-olefin sulfonates, alkane sulfonates, alkylbenzene sulfonates, sulfosuccinic acid ester salts, alkyl sulfate ester salts, alkyl ether sulfate ester salts, alkyl phosphate ester salts, alkyl ether phosphate ester salts, alkyl ether carboxylate, alpha-sulfo fatty acid methyl ester salts, and methyl taur phosphates and the like.

Cationic surfactants include alkyltrimethylammonium salts, dialkyldimethylammonium salts, alkyldimethylbenzylammonium salts, alkylpyridinium salts and the like.

Amphoteric surfactants include alkyl betaine, fatty acid amide propyl betaine, alkyl amine oxide and the like.

Nonionic surfactants include glycerin fatty acid esters, polyglycerin fatty acid esters, sucrose fatty acid esters, sorbitan fatty acid esters, polyoxyethylene sorbitan fatty acid esters, polyoxyethylene alkyl ethers, polyoxyethylene alkyl phenyl ethers, polyoxyethylene fatty acid esters, fatty acid alkanolamides, alkyl glucosides and the like.

In addition, there are fluorochemical surfactants, cellulose derivatives, polymeric surfactants such as polycarboxylates, and polystyrene sulfonates.

In the pulverizing step, in order to enable metal particles having a narrow particle size distribution to be efficiently obtained in a short time, the ratio of the mass of the metal material to the mass of the dispersion medium is preferably 0.07 to 0.5, more preferably 0.1 to 0.35. When the ratio of the mass of the metal material to the mass of the dispersion medium is in this range, it is possible to prevent a coarse metal material from remaining due to an increase in the viscosity of a mixture of the metal material and the dispersion medium, and also possible to prevent a decrease in pulverization efficiency.

In the rotary cylinder type ball mill and the batch type media-stirring type mill, the pulverizing time indicates a cumulative time of rotational movement. In the circulation type media-stirring type mill, the average residence time of the metal material in the pulverizing container is defined as a pulverizing time. The pulverizing time in the circulation type media-stirring type mill can be calculated by the following formula 2.

$${t}_{mill} = {t}_{circ} \times \frac{( {V}_{C} - {V}_{B} )}{( {V}_{DM , T} + {V}_{M , T} + {V}_{NM , T} )} \\ = {t}_{circ} \times \frac{( {V}_{C} - {W}_{B} / {ρ}_{B} )}{( {W}_{DM , T} / {ρ}_{DM , T} + {W}_{M , T} / {ρ}_{M , T} + {W}_{NM , T} / {ρ}_{NM , T} )} \qquad [ Numerical Formula 2 ]$$

where the respective symbols are
tₘᵢₗₗ: pulverizing time, t_{circ}: time during which dispersion liquid is circulating in rotationally moving pulverizing apparatus, V_{M,T}: volume of circulating metal material, W_{M,T}: mass of circulating metal material, ρ_{M,T}: density of metal material, V_{B}: volume of beads, W_{B}: mass of beads, ρ_{B}: true density of beads, V_{DM,T}: volume of circulating dispersion medium, W_{DM,T}: mass of circulating dispersion medium, ρ_{DM,T}: density of dispersion medium, V_{NM,T}: volume of materials other than circulating metal, W_{NM,T}: mass of materials other than circulating metal, ρ_{NM,T}: density of materials other than metal.

The pulverizing time is preferably 0.01 to 10 hours. More preferably it is 0.05 to 5 hours. Particularly preferably it is 0.05 hours to 2 hours. Since the re-agglomeration of metal particles can be suppressed by performing the pulverizing step in this range, metal particles having a narrow particle size distribution can be obtained.

If the pulverizing temperature is too high or too low in the pulverizing step, the mechanical properties of the metal material change and it becomes difficult to obtain particles having a uniform particle size distribution. Therefore, the temperature of the pulverizing container is preferably adjusted to be within a constant temperature range. Since heat is generated accompanying pulverization, it is preferable to cool the pulverizing container so as to maintain the inside of the pulverizing container within a constant temperature range during operation of the pulverizing apparatus.

In wet pulverization using a dispersion medium, it is preferable that the temperature of the pulverizing container is sufficiently higher than the melting point of the liquid dispersion medium and sufficiently lower than the boiling point of the liquid dispersion medium. The temperature in pulverization is preferably 0° C. to 100° C., more preferably 5° C. to 50° C.

Multiple pulverizing steps may be performed. When multiple pulverizing steps are performed, in each pulverizing step, the pulverizing conditions such as the type of stirrer, beads, ratio of the mass of the metal material to the mass of the beads, peripheral speed of the rotating body, dispersion medium, and ratio of the mass of the metal material to the dispersion medium may be different.

For example, the method for producing metal particles including a “first pulverizing step” and a “second pulverizing step” is a method for producing a metal particle composition, comprising:

the first pulverizing step of pulverizing a metal material containing a metal simple substance having a Mohs hardness of 2.5 to 6.3 by beads (1) to obtain metal particles (1) using a media-stirring type pulverizer equipped with a pulverizing container and a rotating body,

a step of separating the metal particles (1) from the beads (1) to take out the beads (1); and

the second pulverizing step of pulverizing the metal material (1) obtained in the take-out step by beads (2) using the media-stirring type pulverizer equipped with the pulverizing container and the rotating body to obtain the metal particles,

wherein, in the first pulverizing step, the mass ratio of the metal material having a Mohs hardness of 2.5 to 6.3 to the beads (1) is 0.02 to 0.10, and the rotating body has a peripheral speed of 2.5 to 8.5 m/s; and
wherein, in the second pulverizing step, the mass ratio of the metal particles (1) to the beads (2) is 0.02 to 0.10, and the rotating body has a peripheral speed of 2.5 to 8.5 m/s.

As for the beads, it is preferable that the average particle diameter of the beads (1) used in the first pulverizing step is larger than the average particle diameter of the beads (2) used in the second pulverizing step. When the respective average particle diameters of the beads (1) and the beads (2) have the above relationship, the re-agglomeration of metal particles can be suppressed.

The average particle diameter of the beads (1) is preferably 0.2 to 2 mm, more preferably 0.2 to 1 mm, and even more preferably 0.2 to 0.6 mm. The average particle diameter of the beads (2) is preferably 0.03 to 0.2 mm, and more preferably 0.05 to 0.2 mm.

In the beads (1) and the beads (2), when the average particle diameters of the respective beads are in the above ranges, and the average particle diameter of the beads (1) is larger than the particle diameter of the beads (2), metal particles having a narrow particle size distribution can be efficiently obtained in a short time.

The method for producing metal particles including the multiple pulverizing steps makes it possible to obtain metal particles having a narrow particle size distribution even when the metal material as a raw metal material has a large average particle diameter, or when the metal material as a raw metal material has a broad particle size distribution, or when the raw material is composed of a plurality of metal materials.

In the first pulverizing step, the ratio of the mass of the metal material having a Mohs hardness of 2.5 to 6.3 to the mass of the beads (1) is preferably 0.02 to 0.09, and more preferably 0.02 to 0.06. In the second pulverizing step, the ratio of the mass of the metal particles (1) to the mass of the beads (2) is preferably 0.02 to 0.09, and more preferably 0.02 to 0.06. When the ratio of the mass of the metal material to the mass of the beads (1) and the ratio of the mass of the metal particles (1) to the mass of the beads (2) are respectively in this range, re-agglomeration of the metal particles is facilitated, so that metal particles having a narrow particle size distribution are obtained.

The metal particles obtained by the method of the present invention are metal particles having a peak top D_{PT} of 0.1 to 1 μm, and a particle size width D₉₀−D₁₀ of 1.7 μm or less as the particle size distribution of the metal particles. According to the method of the present invention, metal particles having a narrow particle size distribution can be efficiently obtained in a short time.

The particle size distribution of the metal particles is such that the peak top D_{PT} is 0.1 to 1 μm, more preferably 0.1 to 0.9 μm, even more preferably 0.1 to 0.3 μm, and that the particle size width D₉₀−D₁₀ is 1.7 μm or less, preferably 5 μm or less, more preferably 1.0 μm or less, even more preferably 0.5 μm or less. Metal particles in this range can repeatedly store and release a large amount of lithium ions with high efficiency as a negative electrode material for lithium ion secondary batteries and the like.

The metal particles may have a D₉₀−D₁₀ value of 0.1 to 1 μm, or 0.1 to 0.9 μm, or 0.1 to 0.3 μm, and a D_{PT} value of 1.7 or less, or 1.5 or less, or 1.0 or less, or 0.5 or less.

<Metal Particle Composition>

When the method of the present invention is a method for producing a metal particle composition, the metal particle composition obtained by the method contains metal particles of a metal material containing a metal simple substance having a Mohs hardness of 2.5 to 6.3, a component derived from a pulverizing container, and a component derived from beads. The component derived from the pulverizing container includes zirconium, aluminum, yttrium, calcium, magnesium, hafnium and the like. The component derived from the beads includes zirconium, aluminum, yttrium, calcium, magnesium, hafnium, silicon, iron, chromium, nickel, carbon, tungsten, and nitrogen.

Preferably, the metal particle composition has a maximum particle diameter (D₁₀₀) of 0.2 to 5.2 μm in a volume-based particle size distribution, contains at least one of zirconium and aluminum, and the total amount of aluminum and zirconium is 0.028 to 1.0 parts by weight with respect to 100 parts by weight of the metal particles.

When the metal particle composition is used as a negative electrode material for lithium ion secondary batteries and the like, it provides a large discharge capacity, excellent coating characteristics, and excellent capacity retention performance before and after high-speed discharge.

Metal simple substances are at least one selected from the group consisting of Ti, Mn, Ge, Nb, Rh, U, Be, Mo, Hf, Co, Zr, Pd, Fe, Ni, As, Pt, Cu, Sb, Th, Al, Mg, Zn, Ag, La, Ce and Au, and preferably at least one selected from the group consisting of Ti, Mn, Ge, Be, Mo, Co, Fe, Ni, Cu, Mg, Zn, Ag, La and Ce. These metal simple substances have the capability of occluding lithium ions. The metal material may be an alloy containing the metal simple substance having the capability of occluding lithium ions.

The metal material is preferably at least one germanium material selected from the group consisting of germanium and germanium alloys because it provides a large charge capacity and discharge capacity per unit weight when used as a negative electrode material for lithium ion secondary batteries and the like. The metal particles of the metal material may contain two or more kinds of metal materials.

When the metal particle composition is used as a negative electrode material for lithium ion secondary batteries, the metal particle composition is made into a slurry in which the metal particle composition is dispersed in a solvent, and the slurry is applied onto a current collector such as a metal foil, and then the solvent is dried to form a negative electrode layer. Keeping the thickness of the negative electrode layer constant extends the repetition lifetime of lithium ion secondary batteries. Therefore, the metal particle composition is required to have the property of being uniformly applied onto the current collector in the state of a slurry dispersed in the solvent without any streaks or uneven thickness, that is, excellent coating characteristics.

The metal particle composition has the maximum particle diameter (D₁₀₀) of 0.2 μm to 4.4 μm, more preferably 0.2 to 3.5 μm, from the viewpoint of improving the coating characteristics. If the maximum particle diameter (D₁₀₀) of the metal particle composition is too large, streaks and uneven thickness occur when applied, leading to electrode defects. If D₁₀₀ is too small, fine metal particles agglomerate in the slurry and become coarse, and also streaks and uneven thickness occur when applied, leading to electrode defects.

The coating characteristics of the metal particle composition can be evaluated, for example, by measuring the size of “grains” of metal particles dispersed in the slurry using “Grindometer” (trade name) manufactured by Allgood Co., Ltd. The Grindometer is formed with a slope-shaped groove that starts from a flat reference surface and gradually deepens. When the groove of the Grindometer is filled with a slurry and scraped with a scraper, grains of metal particles appear somewhere in the stage where the groove gradually becomes shallower. The depth at which grains appear serves as an evaluation value. It means that the smaller the value measured by the Grindometer, the better the coating characteristics of the metal particle composition.

In the metal particle composition, zirconium and aluminum may be contained in the state of a metal simple substance or may be contained in the state of an oxide. Usually, these are contained in the state of an oxide.

In the metal particle composition, from the viewpoint of improving the capacity retention performance before and after high-speed discharge, the total amount of zirconium and aluminum is more preferably 0.028 to 0.146 parts by weight, even more preferably 0.050 to 0.146, and particularly preferably 0.050 to 0.10 parts by weight, with respect to 100 parts by weight of metal particles.

In the metal particle composition, zirconium may be contained in an amount of 0.014 to 0.124 parts by weight, more preferably 0.039 to 0.124 parts by weight, and even more preferably 0.039 to 0.071 parts by weight, with respect to 100 parts by weight of the metal particles. Further, in the metal particle composition, aluminum may be contained in an amount of 0.014 to 0.035 parts by weight, more preferably 0.014 to 0.022 parts by weight, with respect to 100 parts by weight of the metal particles.

The above upper limit values and lower limit values may be optionally combined.

The capacity retention performance before and after high-speed discharge can be evaluated, for example, by measuring the capacity retention rate before and after the 10 C rate discharge. The C (Capacity) rate is a ratio of the discharge current value to the battery capacity (discharge current (A)/capacity (Ah)). The capacity retention rate before and after 10 C rate discharge means a rate of the 0.5 C discharge capacity after performing the 10 C rate discharge test to the 0.5 C discharge capacity before performing the 10 C rate discharge test when metal particles are used as a negative electrode material for lithium ion secondary batteries. Here, the C rate is an index of the discharge rate of a battery, and is a discharge current for completely discharging the designed discharge capacity of the battery in 1/(C rate) time.

In the case of the 0.5 C rate discharge, it means a discharge test in which a discharge current for discharging the design capacity of a battery in 120 minutes is passed through the battery. In the case of the 10 C rate discharge, it means a discharge test in which a discharge current for discharging the design capacity of the battery in 6 minutes is passed through the battery. The theoretical discharge capacity of the negative electrode material is used as the design discharge capacity of the battery in the lithium ion secondary battery using the metal particles as the negative electrode material. For example, when germanium is used as the metal particles, with the charged state of germanium serving as Li₂₂Ge₅, the theoretical discharge capacity of the germanium negative electrode material calculated therefrom is 1624 mAh/g.

The metal particle composition may contain, in addition to the metal particles, the zirconium and the aluminum, at least one substance selected from the group consisting of B, C, Na, P, S, K, Ca, Si, Y, Sc, Cr, Ce and W or oxides thereof, and other substances. These substances may be contained in the metal particle composition by performing the method for producing a metal particle composition.

The content of the metal particles in the metal particle composition is preferably 99 parts by weight to 99.972 parts by weight, and more preferably 99.854 parts by weight to 99.972 parts by weight, with respect to 100 parts by weight of the solid content of the metal particle composition. By the metal particles satisfying the above ranges, a superior capacity retention rate before and after the 10 C rate discharge is achieved when the composition is used as the negative electrode material for lithium ion secondary batteries.

The method for producing the metal particle composition is not limited to the method of the present invention. For example, a production method using thermal plasma, an addition method to add at least one of simple substances or compounds of zirconium and aluminum when producing metal particles, or the like may be used.

In the case of the thermal plasma method, at least one of simple substances or compounds of zirconium and aluminum is used as a raw material.

In the case of the addition method, at least one of simple substances or compounds of zirconium and aluminum may be used as a raw material.

### EXAMPLES

The present invention will be described in more detail by the following Examples.

<Measurement of Particle Size Distribution>

The particle size distributions of dispersion liquids obtained in Examples and Comparative Examples were measured using a laser diffraction type particle size distribution measuring device (Mastersizer 2000 (Hydro S) manufactured by Malvern Panalytical Ltd.) The dispersions obtained in Examples and Comparative Examples were dispersed in water by ultrasonic waves and stirring, and using 3.07-i (a real part 3.07, an imaginary part 1) as the refractive index of the germanium material, the particle size distributions of metal particles in the dispersion liquids were measured.

When the particle size distribution was accumulated from the fine particle side on a volume basis, a particle diameter indicating 10% in the cumulative value was defined as D₁₀, and a particle diameter indicating 90% was defined as D₉₀. The particle diameter corresponding to a vertex (peak top) of a mountain-shaped distribution profile in the volume-based particle size distribution obtained by calculating the particle size distribution width D₉₀−D₁₀ from D₁₀ and D₉₀ was defined as D_{PT}. However, when there are two or more vertices of the mountain-shaped distribution profile, the particle diameter corresponding to a vertex with a higher detection frequency was defined as D_{PT}.

In the volume-based particle size distribution, when the particle size distribution was accumulated from the fine particle side on the volume basis, a particle diameter corresponding to 100% in the cumulative value was defined as D₁₀₀.

<Component Analysis of Composition>

The measurement was performed by inductively coupled plasma emission spectrometry (hereinafter sometimes referred to as ICP-AES) using a composition analyzer (SPS 3000 manufactured by SII Nanotechnology Inc.) 0.2 g of tartaric acid was added to 10 mg of a composition obtained by drying a dispersion liquid obtained in Examples and Comparative Examples, and 10 mL of nitric acid was added thereto to dissolve the composition. Further, 10 mL of sulfuric acid was added thereto and heated at 200° C. to completely dissolve the composition. After confirming that the composition and tartaric acid were completely dissolved, heating was stopped, and the mixture was allowed to cool. 100 ppm Sc Standard Solution (manufactured by Wako Pure Chemical Industries, Ltd.) was added as an internal standard substance. 1000 ppm Sc was added as an internal standard substance to a solution prepared by the same operation except that the composition was not used, and then 1000 ppm Zr Standard Solution (manufactured by Fujifilm Wako Pure Chemical Industries, Ltd.) and 1000 ppm Al Standard Solution (manufactured by Wako Pure Chemical Industries, Ltd.) were added thereto to prepare a standard sample. The composition analysis measurement was performed using the composition solution and the standard sample, and the Zr and Al contents of the composition were obtained by a calibration curve method. In the composition analysis measurement, the composition solution or the standard sample was sprayed on plasma to obtain the signal intensities corresponding to Zr, Al and Sc. The wavelengths obtained at this time were 339 nm for Zr, 396 nm for Al, and 363 nm for Sc, respectively.

<Evaluation of Coatability>

Evaluation was performed using a grindometer (manufactured by Nippon Cedars Service Co., Ltd., grind gauge 100 μm). A negative electrode slurry composed of a negative electrode material of a composition containing metal particles, a conductive material, a binder, and a solvent was prepared as below.

(a) Negative electrode material: Composition containing metal particles
(b) Conductive material: Acetylene black (manufactured by Denka Company Limited, product number: Denka Black HS100)
(c) Binder: PVdF (manufactured by Kureha Corporation)
(d) Solvent: N-methyl-2-pyrrolidone (hereinafter sometimes referred to as “NMP”)

The negative electrode material, conductive material, binder, and solvent were adjusted to have a weight ratio of the negative electrode material: the conductive material: the binder of 80:10:10, and these were kneaded using a agate mortar to prepare a negative electrode slurry. The lower the total weight (solid content concentration) of the negative electrode material, the conductive material, and the binder in the negative electrode slurry, the lower the viscosity and the easier to coat; the higher the total weight, the higher the viscosity and the more difficult to coat. NMP was added and adjusted so that the solid content concentration was 45 to 50% by weight, and the solid content concentration was kept constant.

A drop of the negative electrode slurry was put on a position where the groove depth of the grindometer was 100 μm. Using a scraper attached to the grindometer, the negative electrode slurry on the grindometer was drawn from the position where the groove depth was 100 μm toward a position where the groove depth was 0 μm. A case in which no grains or streaks were observed from the position where the groove depth was 100 μm to the position where the groove depth was 0 μm, and a case in which grains or streaks were observed between a position where the groove depth was less than 50 μm and the position where the groove depth was 0 μm were considered good as a film. A case in which grains or streaks were observed between the position where the groove depth was 100 μm and a position where the groove depth was 50 μm or more was considered defective as a film.

When grains or streaks containing the negative electrode material are formed on the film, the thickness of a negative electrode layer using the film as a forming material becomes non-uniform, resulting in a shortened repetition lifetime of the lithium ion secondary battery.

<Preparation of Electrode>

A negative electrode slurry composed of a negative electrode material of a composition containing metal particles, a conductive material, a binder, and a solvent was prepared as below.

(a) Negative electrode material: Composition containing metal particles
(b) Conductive material: Acetylene black (manufactured by Denka Company Limited, product number: Denka Black HS100)
(c) Binder: PVdF (manufactured by Kureha Corporation)
(d) Solvent: N-methyl-2-pyrrolidone (hereinafter sometimes referred to as “NMP”)

The negative electrode material, conductive material, binder, and solvent were adjusted to have a weight ratio of the negative electrode material: the conductive material: the binder of 80:10:10, and these were kneaded using a agate mortar to prepare a negative electrode slurry. NMP was added and adjusted so that the total weight of the negative electrode material, the conductive material, and the binder in the negative electrode slurry was 30 to 60% by weight.

The negative electrode slurry was applied to a copper foil current collector using a doctor blade, then air-dried at 60° C. for 1.5 hours to dry the solvent, pressed with a roll press, and then further vacuum dried at 150° C. for 8 hours to obtain an electrode.

<Production of Lithium Ion Secondary Battery>

A lithium ion secondary battery (coin-type battery R2032) was prepared by combining an electrode with a composition containing metal particles serving as a negative electrode, a counter electrode, an electrolytic solution, and a separator. The assembly of the battery was performed in a glove box with an argon atmosphere.

As the electrode, an electrode with the composition containing the metal particles serving as the negative electrode material was used.

As the electrolytic solution, the one obtained by dissolving LiPF₆ as an electrolyte in a mixed solvent of ethylene carbonate and diethyl carbonate in a volume ratio of 30:70 was used.

As the separator, a porous separator made of polypropylene was used. Metal lithium was used as the counter electrode.

Charge/Discharge Test

A charge/discharge test method when a composition containing germanium as the metal particles was used as a negative electrode material is shown. The charge/discharge test was carried out under holding at 25° C. and under the conditions shown below using an electrode with the composition serving as the negative electrode material, and using the thus produced coin-type battery. In the charge/discharge test, the discharge capacity was measured changing the discharge current at the time of discharge. The charge current in each cycle was kept constant at a 0.2 C rate.

Minimum charge voltage: 0.01 V

Charge current: 0.2 C (325 mA/g-Ge)

Maximum discharge voltage: 1.0 V

Discharge current: Predetermined C rate

The discharge was performed changing the discharge current in each cycle as follows. The discharge current was calculated using the current value per germanium weight contained in the electrode according to the C rate of each cycle.

1st cycle discharge (0.2 C): discharge current 325 mA/g-Ge
2nd cycle discharge (0.2 C): discharge current 325 mA/g-Ge
3rd cycle discharge (0.5 C): discharge current 812 mA/g-Ge
4th cycle discharge (1 C): discharge current 1624 mA/g-Ge
5th cycle discharge (2 C): discharge current 3248 mA/g-Ge
6th cycle discharge (4 C): discharge current 6496 mA/g-Ge
7th cycle discharge (6 C): discharge current 9744 mA/g-Ge
8th cycle discharge (8 C): discharge current 12992 mA/g-Ge
9th cycle discharge (10 C): discharge current 16240 mA/g-Ge
10th cycle discharge (0.5 C): discharge current 812 mA/g-Ge

The capacity retention rate before and after the 10 C rate discharge was defined as a ratio of the discharge capacity obtained by the 0.5 C rate discharge in the 10th cycle to the discharge capacity obtained by the 0.5 C rate discharge in the 3rd cycle. The larger the after rate capacity retention rate, the smaller the deterioration of the negative electrode material after passing a large discharge current, and the better it is as the negative electrode material.

### Example 1

Using a bead mill (manufactured by AIMEX Co, Ltd., a batch type readymill RMB-08) as a batch type media-stirring type mill, germanium metal with a mass of 6.0 g (manufactured by High Purity Chemical Co., Ltd., 45 μm pass, true density 5.3 g/mL, Mohs hardness 6.0, D₉₀−D₁₀=21.52, D_{PT}=15.89) as metal material 1, 108 g of zirconia beads (0.1 mmφ, true density 5.7 g/mL) as beads, and isopropyl alcohol (manufactured by Fujifilm Wako Pure Chemical Industries, Ltd., true density 0.79 g/mL) with a mass of 24.0 g as a dispersion medium were charged in this pulverizing container (outer cylinder material: SUS304, inner cylinder material: zirconia, and the like, effective volume: 125 mL). A shaft made of zirconia was set up, the beads were stirred by rotation of the shaft, and the metal material 1 was wet-pulverized. When performing wet pulverization, water was run between the outer cylinder and the inner cylinder of the pulverizing container using a chiller set to 10° C. so that the temperature of the pulverizing container was 10° C. to 50° C., which was sufficiently higher than the melting point of the dispersion medium, and was sufficiently lower than the boiling point of the dispersion medium.

Wet pulverization was performed with the ratio of the mass of the metal material 1 to the mass of the beads set to 0.056, the sum of the mass of the metal material and the mass of the dispersion medium set to 30.0 g, and the peripheral speed set to 3 m/s. After the pulverization time reached 60 minutes, the apparatus was stopped, and dispersion liquid A1 was obtained. When the particle size distribution of the dispersion liquid A1 was measured, the particle size width D₉₀−D₁₀ was 0.46 μm, and the peak top D_{PT} was 0.18 μm.

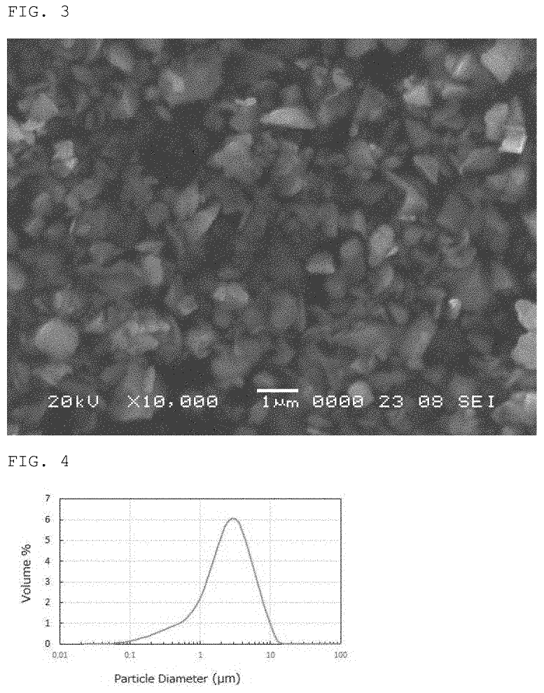

In a particle size distribution diagram of the dispersion liquid A1 obtained in Example 1, the peak of the distribution was in 0.1 to 1.0 μm. Few coarse particles larger than 1.0 μm and fine particles smaller than 0.1 μm were observed (FIG. 2).

In an observation image of the germanium particles obtained by drying the dispersion liquid A1 obtained in Example 1 with a scanning electron microscope, particles smaller than 1.0 μm were observed (FIG. 3).

### Example 2

Wet pulverization was performed under the same conditions as in Example 1 except that the ratio of the mass of the metal material 1 to the mass of the beads was set to 0.083, and dispersion liquid A2 was obtained. When the particle size distribution of the dispersion liquid A2 was measured, the particle size width D₉₀−D₁₀ was 1.10 μm, and the peak top D_{PT} was 0.89 μm.

### Example 3

Wet pulverization was performed under the same conditions as in Example 1 except that the peripheral speed was set to 5 m/s, and dispersion liquid A3 was obtained. When the particle size distribution of the dispersion liquid A3 was measured, the particle size width D₉₀−D₁₀ was 1.50 μm, and the peak top D_{PT} was 0.89 μm.

### Example 4

Using a bead mill (manufactured by AIMEX Co, Ltd., a batch type readymill RMB-08) as a batch type media-stirring type mill, germanium metal with a mass of 39.0 g (manufactured by High Purity Chemical Co., Ltd., 45 μm pass, true density 5.3 g/mL, Mohs hardness 6.0, D₉₀−D₁₀=21.52, D_{PT}=15.89) as metal material 1, 108 g of zirconia beads (0.1 mmφ, true density 5.7 g/mL) as beads, and isopropyl alcohol (manufactured by Fujifilm Wako Pure Chemical Industries, Ltd., true density 0.79 g/mL) with a mass of 157 g as a dispersion medium were put in this pulverizing container (outer cylinder material: SUS304, inner cylinder material: zirconia, and the like, effective volume: 820 mL). A shaft made of zirconia was set up, the beads were stirred by rotation of the shaft, and the metal material 1 was wet-pulverized. When performing wet pulverization, an aqueous solution of ethylene glycol was run between the outer cylinder and the inner cylinder of the pulverizing container using a chiller set to 10° C. so that the temperature of the pulverization container was 10° C. to 50° C., which was sufficiently higher than the melting point of the dispersion medium, and was sufficiently lower than the boiling point of the dispersion medium. The ratio of the mass of the metal material 1 to the mass of the beads was adjusted to 0.056, and the peripheral speed was adjusted to 8 m/s. After the pulverization time reached 60 minutes, the apparatus was stopped, and the dispersion liquid A4 was obtained. When the particle size distribution of the dispersion liquid A4 was measured, the particle size width D₉₀−D₁₀ was 1.48 μm, and the peak top D_{PT} was 1.00 μm.

### Comparative Example 1

Wet pulverization was performed under the same conditions as in Example 1 except that the ratio of the mass of the metal material 1 to the mass of the beads was set to 0.014, and dispersion liquid B1 was obtained. When the particle size distribution of the dispersion liquid B1 was measured, the particle size width D₉₀−D₁₀ was 5.16 μm, and the peak top D_{PT} was 2.83 μm.

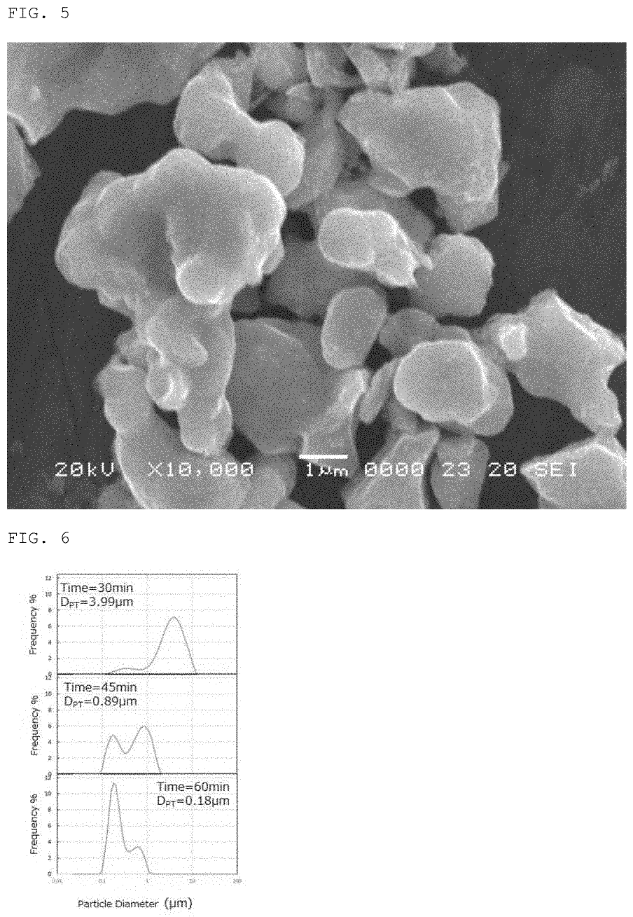

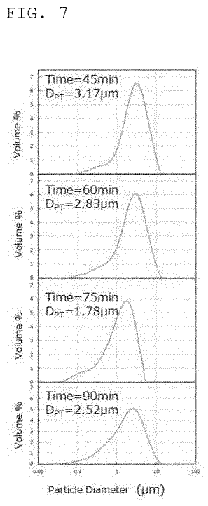

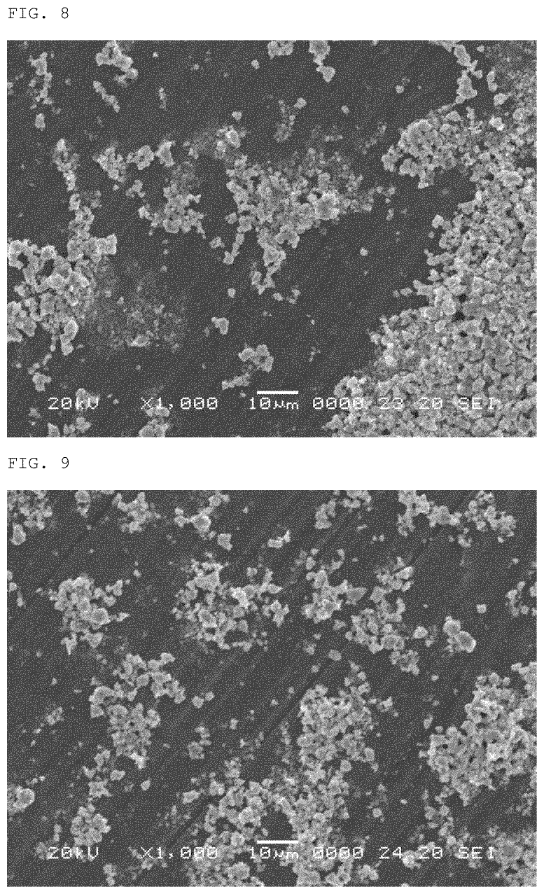

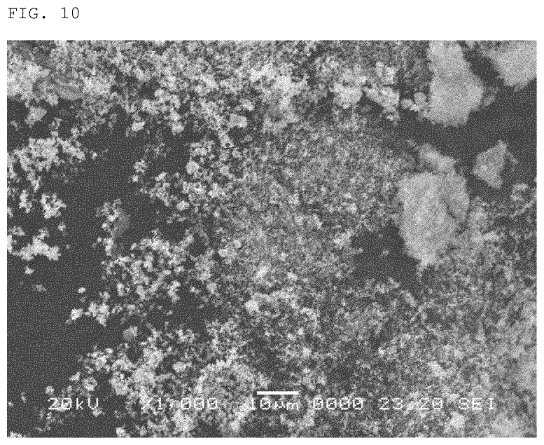

In a particle size distribution diagram of the dispersion liquid B1 obtained in Comparative Example 1, the particle size distribution ranged from fine particles smaller than 0.1 μm to coarse particles exceeding 10 μm (FIG. 4).

In an observation image of the germanium particles obtained by drying the dispersion medium of the dispersion liquid B1 obtained in Comparative Example 1 using the scanning electron microscope, many coarse particles having a particle diameter exceeding 2.0 μm were observed. (FIG. 5).

### Comparative Example 2

Wet pulverization was performed under the same conditions as in Example 1 except that the ratio of the mass of the metal material 1 to the mass of the beads was set to 0.111, and dispersion liquid B2 was obtained. When the particle size distribution of the dispersion B2 was measured, the particle size width D₉₀−D₁₀ was 3.71 μm, and the peak top D_{PT} was 2.52 μm.

### Comparative Example 3

Wet pulverization was performed under the same conditions as in Example 1 except that the peripheral speed was set to 2 m/s, and dispersion liquid B3 was obtained. When the particle size distribution of the dispersion liquid B3 was measured, the particle size width D₉₀−D₁₀ was 21.78 μm, and the peak top D_{PT} was 15.89 μm.

### Comparative Example 4

Wet pulverization was performed under the same conditions as in Example 4 except that the peripheral speed was set to 9 m/s, and dispersion liquid B4 was obtained. When the particle size distribution of the dispersion liquid B4 was measured, the particle size width D₉₀−D₁₀ was 1.84 μm, and the peak top D_{PT} was 1.13 μm.

TABLE 1

| | Pulverizing conditions | | | | | | | | | | Particle size | |
|---|---|---|---|---|---|---|---|---|---|---|---|---|
| | | | | Effective | Metal | | Dispersion | Metal | Peripheral | Pulverizing | distribution | |
| | Metal | Beads | Dispersion | volume | material | Beads | medium | material/ | speed | time | D₉₀-D₁₀ | |
| | material | [mmφ] | medium | [mL] | [g] | [g] | [g] | Beads | [m/s] | [min] | [μm] | D_{PT} |
| Example | Metal | ZrO₂_0.1φ | IPA | 125 | 6 | 108 | 24 | 0.056 | 3 | 60 | 0.46 | 0.18 |
| 1 | material 1 | | | | | | | | | | | |
| Example | Metal | ZrO₂_0.1φ | IPA | 125 | 9 | 108 | 21 | 0.083 | 3 | 60 | 1.10 | 0.89 |
| 2 | material 1 | | | | | | | | | | | |
| Example | Metal | ZrO₂_0.1φ | IPA | 125 | 6 | 108 | 24 | 0.056 | 5 | 60 | 1.50 | 0.89 |
| 3 | material 1 | | | | | | | | | | | |
| Example | Metal | ZrO₂_0.1φ | IPA | 820 | 39 | 708 | 157 | 0.056 | 8 | 60 | 1.48 | 1.00 |
| 4 | material 1 | | | | | | | | | | | |
| Comp. | Metal | ZrO₂_0.1φ | IPA | 125 | 1.5 | 108 | 28.5 | 0.014 | 3 | 60 | 5.16 | 2.83 |
| Example | material 1 | | | | | | | | | | | |
| 1 | | | | | | | | | | | | |
| Comp. | Metal | ZrO₂_0.1φ | IPA | 125 | 12 | 108 | 18 | 0.111 | 3 | 60 | 3.71 | 2.52 |
| Example | material 1 | | | | | | | | | | | |
| 2 | | | | | | | | | | | | |
| Comp. | Metal | ZrO₂_0.1φ | IPA | 125 | 6 | 108 | 24 | 0.056 | 2 | 60 | 21.78 | 15.89 |
| Example | material 1 | | | | | | | | | | | |
| 3 | | | | | | | | | | | | |
| Comp. | Metal | ZrO₂_0.1φ | IPA | 820 | 39 | 708 | 157 | 0.056 | 9 | 60 | 1.84 | 1.13 |
| Example | material 1 | | | | | | | | | | | |
| 4 | | | | | | | | | | | | |

### Example 5

As a circulation type media-stirring type mill, using a bead mill for circulation operation equipped with a zirconia shaft (manufactured by Ashizawa Finetech Ltd, continuous stirring mill LMZ015, inner cylinder material: zirconia toughened alumina, effective volume of pulverizing container: 170 mL), zirconia beads (0.8 mmφ, true density 5.7 g/mL) with a mass of 585 g were charged as beads in a pulverizing container. Isopropyl alcohol (manufactured by Fujifilm Wako Pure Chemical Industries, Ltd., true density 0.79 g/mL) with a mass of 560 g was circulated in the bead mill for circulation operation at a flow rate of 350 mL/min. It was operated at a peripheral speed of 8 m/s. Germanium metal (manufactured by High Purity Chemical Co., Ltd., 300 μm pass, true density 5.3 g/mL, Mohs hardness 6.0, D₉₀−D₁₀=240.19, D_{PT}=39.91) with a mass of 140 g as metal material 2 was dispersed in isopropyl alcohol, sent to the bead mill for circulation operation, and wet pulverized (first pulverizing step). When performing wet pulverization, water was run between the outer cylinder and the inner cylinder of the pulverizing container using a chiller set to 5° C., so that the temperature of the pulverizing container was 10° C. to 50° C., which was sufficiently higher than the melting point of the dispersion medium, and was sufficiently lower than the boiling point of the dispersion medium. In Example 5, the ratio of the mass of the metal material 2 to the mass of the zirconia beads was 0.022. When the pulverization time reached 8 minutes, dispersion liquid A5 in which the germanium particles were dispersed was obtained. When the particle size distribution of the dispersion liquid A5 was measured, the particle size width D₉₀−D₁₀ was 1.07 μm, and the peak top D_{PT} was 0.75 μm.

### Example 6

601 g of zirconia beads (0.1 mmφ) were charged as beads in the same bead mill for circulation operation as in Example 5. It was operated at a peripheral speed of the shaft of 8 m/s. 400 g of the dispersion liquid A5 was circulated at 150 mL/min so that the ratio of the mass of the metal material 2 (metal material 2-A5) contained in the dispersion liquid A5 obtained in Example 5 to the mass of the zirconia beads was 0.020, water was circulated using a chiller set to 5° C., and wet pulverization was performed (second pulverizing step). When the pulverizing time reached 6 minutes, dispersion liquid A6 in which the germanium particles were dispersed was obtained. When the particle size distribution of the dispersion liquid A6 was measured, the particle size width D₉₀−D₁₀ was 0.39 μm, and the peak top D_{PT} was 0.22 μm.

Pulverizing the dispersion liquid having a larger volume than the volume of the pulverizing container by using the bead mill for circulation operation as the circulation type media-stirring type mill made it possible to obtain metal particles having a narrow particle size distribution in a shorter pulverizing time.

The particles obtained in the second pulverizing step of Example 6 have smaller values in both the particle size width D₉₀−D₁₀ and the peak top D_{PT} compared with the particles obtained in the first pulverizing step of Example 5, and more homogeneous metal particles could be obtained without leaving any coarse particles of the metal material.

TABLE 2

| | Pulverizing conditions | | | | | | | | | | Particle size | |
|---|---|---|---|---|---|---|---|---|---|---|---|---|
| | | | | Effective | Metal | | Dispersion | Metal | Peripheral | Pulverizing | distribution | |
| | Metal | Beads | Dispersion | volume | material | Beads | medium | material/ | speed | time | D₉₀-D₁₀ | |
| | material | [mmφ] | medium | [mL] | [g] | [g] | [g] | Beads | [m/s] | [min] | [μm] | D_{PT} |
| Example | Metal | ZrO₂_0.8φ | IPA | 170 | 140 | 585 | 560 | 0.022 | 8 | 8 | 1.07 | 0.75 |
| 5 | material | | | | | | | | | | | |
| | 2-A5 | | | | | | | | | | | |
| Example | Metal | ZrO₂_0.1φ | IPA | 170 | 80 | 611 | 320 | 0.020 | 8 | 6 | 0.39 | 0.22 |
| 6 | material | | | | | | | | | | | |
| | 2-A6 | | | | | | | | | | | |

### Example 7

Wet pulverization was performed under the same conditions as in Example 1 except that 6 g of germanium metal as metal material 2 (manufactured by High Purity Chemical Co., Ltd., 300 μm pass, true density 5.3 g/mL, Mohs hardness 6.0, D₉₀−D₁₀=240.19, D_{PT}=39.91), and 108 g of zirconia beads (0.5 mmφ, true density 5.7 g/mL) as beads were used, and dispersion liquid A7 was obtained (first pulverizing step). When the particle size distribution of the metal material 2 (metal material 2-A7) in the dispersion liquid A7 was measured, the particle size width D₉₀−D₁₀ was 1.20 μm, and the peak top D_{PT} was 0.71 μm.

### Example 8

Wet pulverization was performed under the same conditions as in Example 1, except that zirconia beads (0.1 mmφ, true density 5.7 g/mL) with a mass of 108 g as beads, the metal material 1, and the dispersion liquid A7 obtained in Example 7 in place of isopropyl alcohol as a dispersion medium were used, and dispersion liquid A8 was obtained (second pulverizing step). When the particle size distribution of the metal material 1 (metal material 1-A8) in the dispersion liquid A8 was measured, the particle size width D₉₀−D₁₀ was 0.12 μm, and the peak top D_{PT} was 0.18 μm.

The particles obtained in the second pulverizing step of Example 8 had smaller values in both the particle size width D₉₀−D₁₀ and the peak top D_{PT} compared with the particles obtained in the first pulverizing step of Example 7.

TABLE 3

| | Pulverizing conditions | | | | | | | | | | Particle size | |
|---|---|---|---|---|---|---|---|---|---|---|---|---|
| | | | | Effective | Metal | | Dispersion | Metal | Peripheral | Pulverizing | distribution | |
| | Metal | Beads | Dispersion | volume | material | Beads | medium | material/ | speed | time | D₉₀-D₁₀ | |
| | material | [mmφ] | medium | [mL] | [g] | [g] | [g] | Beads | [m/s] | [min] | [μm] | D_{PT} |
| Example | Metal | ZrO₂_0.5φ | IPA | 125 | 6 | 108 | 24 | 0.056 | 3 | 60 | 1.20 | 0.71 |
| 7 | material | | | | | | | | | | | |
| | 2-A7 | | | | | | | | | | | |
| Example | Metal | ZrO₂_0.1φ | IPA | 125 | 6 | 108 | 24 | 0.056 | 3 | 60 | 0.12 | 0.18 |
| 8 | material | | | | | | | | | | | |
| | 2-A8 | | | | | | | | | | | |

### Example 9

Wet pulverization was performed under the same conditions as in Example 7 except that zirconia beads (0.8 mmφ, true density 5.7 g/mL) with a mass of 108 g were used as beads, and dispersion liquid A9 was obtained (first pulverizing step). When the particle size distribution of the metal material 2 (metal material 2-A9) in the dispersion liquid A9 was measured, the particle size width D₉₀−D₁₀ was 1.57 μm, and the peak top D_{PT} was 1.12 μm.

### Example 10

Wet pulverization was performed under the same conditions as in Example 8 except that the dispersion liquid A9 obtained in Example 9 was used in place of the dispersion liquid A7, and dispersion liquid A10 was obtained (second pulverizing step). When the particle size distribution of the metal material 2 (metal material 2-A10) in the dispersion liquid A10 was measured, the particle size width D₉₀−D₁₀ was 0.36 μm, and the peak top D_{PT} was 0.18 μm.

TABLE 4

| | Pulverizing conditions | | | | | | | | | | Particle size | |
|---|---|---|---|---|---|---|---|---|---|---|---|---|
| | | | | Effective | Metal | | Dispersion | Metal | Peripheral | Pulverizing | distribution | |
| | Metal | Beads | Dispersion | volume | material | Beads | medium | material/ | speed | time | D₉₀-D₁₀ | |
| | material | [mmφ] | medium | [mL] | [g] | [g] | [g] | Beads | [m/s] | [min] | [μm] | D_{PT} |
| Example | Metal | ZrO₂_0.8φ | IPA | 125 | 6 | 108 | 24 | 0.056 | 3 | 60 | 1.57 | 1.12 |
| 9 | material | | | | | | | | | | | |
| | 2-A9 | | | | | | | | | | | |
| Example | Metal | ZrO₂_0.1φ | IPA | 125 | 6 | 108 | 24 | 0.056 | 3 | 60 | 0.36 | 0.18 |
| 10 | material | | | | | | | | | | | |
| | 2-A10 | | | | | | | | | | | |

### Example 11

Wet pulverization was performed under the same conditions as in Example 9 except that ethanol with a mass of 24 g (manufactured by Fujifilm Wako Pure Chemical Industries, Ltd., true density 0.79 g/mL) was used as the dispersion medium, and dispersion liquid A11 was obtained (first pulverizing step). When the particle size distribution of the metal material 2 (metal material 2-A11) in the dispersion liquid A11 was measured, the particle size width D₉₀−D₁₀ was 1.64 μm, and the peak top D_{PT} was 1.00 μm.

### Example 12

Wet pulverization was performed under the same conditions as in Example 10 except that the dispersion liquid A11 obtained in Example 11 was used in place of the dispersion liquid 9, and dispersion liquid A12 was obtained (second pulverizing step). When the particle size distribution of the metal material 2 (metal material 2-A12) in the dispersion liquid A12 was measured, the particle size width D₉₀−D₁₀ was 0.39 μm, and the peak top D_{PT} was 0.20 μm.

TABLE 5

| | Pulverizing conditions | | | | | | | | | | Particle size | |
|---|---|---|---|---|---|---|---|---|---|---|---|---|
| | | | | Effective | Metal | | Dispersion | Metal | Peripheral | Pulverizing | distribution | |
| | Metal | Beads | Dispersion | volume | material | Beads | medium | material/ | speed | time | D₉₀-D₁₀ | |
| | material | [mmφ] | medium | [mL] | [g] | [g] | [g] | Beads | [m/s] | [min] | [μm] | D_{PT} |
| Example | Metal | ZrO₂_0.8φ | EtOH | 125 | 6 | 108 | 24 | 0.056 | 3 | 60 | 1.64 | 1.00 |
| 11 | material | | | | | | | | | | | |
| | 2-Al 1 | | | | | | | | | | | |
| Example | Metal | ZrO₂_0.1φ | EtOH | 125 | 6 | 108 | 24 | 0.056 | 3 | 60 | 0.39 | 0.20 |
| 12 | material | | | | | | | | | | | |
| | 2-Al2 | | | | | | | | | | | |

<Changes over time in particle size distribution of metal particles in Example 1>

TABLE 6

| | Pulverizing conditions | | | | | | | | | | Particle size | |
|---|---|---|---|---|---|---|---|---|---|---|---|---|
| | | | | Effective | Metal | | Dispersion | Metal | Peripheral | Pulverizing | distribution | |
| | Metal | Beads | Dispersion | volume | material | Beads | medium | material/ | speed | time | D₉₀-D₁₀ | |
| | material | [mmφ] | medium | [mL] | [g] | [g] | [g] | Beads | [m/s] | [min] | [μm] | D_{PT} |
| Example | Metal | ZrO₂_0.1φ | IPA | 125 | 6 | 108 | 24 | 0.056 | 3 | 30 | 5.90 | 3.99 |
| 1 | material 1 | | | | | | | | | | | |
| | Metal | ZrO₂_0.1φ | IPA | 125 | 6 | 108 | 24 | 0.056 | 3 | 45 | 1.01 | 0.89 |
| | material 1 | | | | | | | | | | | |
| | Metal | ZrO₂_0.1φ | IPA | 125 | 6 | 108 | 24 | 0.056 | 3 | 60 | 0.46 | 0.18 |
| | material 1 | | | | | | | | | | | |

In Example 1, the respective dispersion liquid A1-30 minutes, dispersion liquid A1-45 minutes, and dispersion liquid A1-60 minutes when the pulverization times were 30 minutes, 45 minutes, and 60 minutes were obtained. Table 6 showed the particle size widths D₉₀−D₁₀ and the peak tops D_{PT} calculated from the particle size distributions of these dispersion liquids.

As the pulverizing time increased, the value of the particle size width D₉₀−D₁₀ and the value of the peak top D_{PT} decreased.

<Changes over time in particle size distribution of metal particles in Comparative Example 1>

TABLE 7

| | Pulverizing conditions | | | | | | | | | | Particle size | |
|---|---|---|---|---|---|---|---|---|---|---|---|---|
| | | | | Effective | Metal | | Dispersion | Metal | Peripheral | Pulverizing | distribution | |
| | Metal | Beads | Dispersion | volume | material | Beads | medium | material/ | speed | time | D₉₀-D₁₀ | |
| | material | [mmφ] | medium | [mL] | [g] | [g] | [g] | Beads | [m/s] | [min] | [μm] | D_{PT} |
| Comp. | Metal | ZrO₂_0.1φ | IPA | 125 | 1.5 | 108 | 28.5 | 0.014 | 3 | 45 | 5.30 | 3.17 |
| Example | material 1 | | | | | | | | | | | |
| 1 | Metal | ZrO₂_0.1φ | IPA | 125 | 1.5 | 108 | 28.5 | 0.014 | 3 | 60 | 5.16 | 2.83 |
| | material 1 | | | | | | | | | | | |
| | Metal | ZrO₂_0.1φ | IPA | 125 | 1.5 | 108 | 28.5 | 0.014 | 3 | 75 | 2.58 | 1.78 |
| | material 1 | | | | | | | | | | | |
| | Metal | ZrO₂_0.1φ | IPA | 125 | 1.5 | 108 | 28.5 | 0.014 | 3 | 90 | 4.65 | 2.52 |
| | material 1 | | | | | | | | | | | |

In Comparative Example 1, the respective dispersion liquid B1-45 minutes, dispersion liquid B1-60 minutes, dispersion liquid B1-75 minutes, and dispersion liquid B1-90 minutes when the pulverization times were 45 minutes, 60 minutes, 75 minutes, and 90 minutes were obtained. Table 7 showed the particle size widths D₉₀−D₁₀ and the peak tops D_{PT} calculated from the particle size distributions of these dispersions. At the pulverizing times of 45 minutes, 60 minutes, and 75 minutes, as the pulverizing time increased, the particle size width D₉₀−D₁₀ and the peak top D_{PT} decreased. On the other hand, when comparing the pulverizing times of 75 minutes and 90 minutes, the value of the particle size width D₉₀−D₁₀ and the value of the peak top D_{PT} increased at the pulverizing time of 90 minutes.

When comparing the particle size distribution of the metal particles obtained at the pulverizing time of 75 minutes with the particle size distribution of the metal particles obtained at the pulverizing time of 90 minutes in Comparative Example 1, the distribution of those less than 0.1 μm was larger at the pulverizing time of 75 minutes than that at the pulverizing time of 90 minutes, whereas at the pulverizing time of 90 minutes, the distribution of particles larger than 3 μm became large.

In the method for producing metal particles of Comparative Example 1, re-agglomeration became more likely to occur accompanying the generation of fine particles smaller than 0.1 μm, the pulverization time increased, and coarse particles larger than 1 μm increased.

### Example 13

As a circulation type media-stirring type mill, using a bead mill for circulation operation equipped with a zirconia shaft (manufactured by Ashizawa Finetech Ltd, continuous stirring mill LMZ2, inner cylinder material: zirconia toughened alumina, effective volume of pulverizing container: 1400 mL), zirconia beads (0.8 mmφ, true density 5.7 g/mL) with a mass of 4900 g were charged as beads in a pulverizing container. Isopropyl alcohol (manufactured by Fujifilm Wako Pure Chemical Industries, Ltd., true density 0.79 g/mL) with a mass of 5600 g was circulated in the bead mill for circulation operation at a flow rate of 4000 mL/min. It was operated at a peripheral speed of 8 m/s. Germanium metal (manufactured by High Purity Chemical Co., Ltd., 300 μm pass, true density 5.3 g/mL, Mohs hardness 6.0, D₉₀−D₁₀=240.19, D_{PT}=39.91) with a mass of 1400 g as metal material 2 was dispersed in isopropyl alcohol, sent to the bead mill for circulation operation, and wet pulverized (first pulverizing step). When performing wet pulverization, water was run between the outer cylinder and the inner cylinder of the pulverizing container using a chiller set to 5° C. so that the temperature of the pulverizing container was 5° C. to 50° C. which was sufficiently higher than the melting point of the dispersion medium, and sufficiently lower than the boiling point of the dispersion medium. When the pulverization time reached 7 minutes, a dispersion liquid in which germanium particles were dispersed was obtained, and 1280 g of isopropyl alcohol was added to further obtain a dispersion liquid in which germanium particles were dispersed in the pulverizing container. The two dispersion liquids were combined to form dispersion liquid A13′.

In the same bead mill for circulation operation, 4600 g of zirconia beads (0.1 mmφ) was charged as beads so that the ratio of the mass of metal material 2 (metal material 2-A13′) contained in the dispersion liquid A13′ to the mass of zirconia beads was 0.020. It was operated at a peripheral speed of the shaft of 8 m/s. 7240 g of dispersion A13 and 760 g of isopropyl alcohol were circulated at a flow rate of 2000 mL/min, and water was circulated using a chiller set to 5° C., and wet pulverization was performed (second pulverizing step). When the pulverizing time reached 13 minutes, dispersion liquid A13 in which the germanium particles were dispersed was obtained. When the particle size distribution of the dispersion liquid A13 was measured, the particle size width D₉₀−D₁₀ was 0.63 μm, and the peak top D_{PT} was 0.22 μm.

TABLE 8

| | Pulverizing conditions | | | | | | | | | | Particle size | |
|---|---|---|---|---|---|---|---|---|---|---|---|---|
| | | | | Effective | Metal | | Dispersion | Metal | Peripheral | Pulverizing | distribution | |
| | Metal | Beads | Dispersion | volume | material | Beads | medium | material/ | speed | time | D₉₀-D₁₀ | |
| | material | [mm]φ | medium | [mL] | [g] | [g] | [g] | Beads | [m/s] | [min] | [μm] | D_{PT} |
| Example | Metal | ZrO₂_0.1φ | IPA | 1400 | 1339.2 | 4600 | 6660.8 | 0.020 | 8 | 13 | 0.63 | 0.22 |
| 13 | material | | | | | | | | | | | |
| | 2-A13 | | | | | | | | | | | |

<Coatability and Capacity Retention Rate Before and after 10 C Rate Discharge>

Table 9 shows zirconium and aluminum contents of the compositions obtained in Comparative Examples 1 to 5, Examples 1 to 4, Example 6, Example 8, Example 12, Example 13, D₁₀₀, and capacity retention rate before and after 10 C rate discharge.

The D₁₀₀ of the compositions obtained in Comparative Example 1 and Comparative Example 3 exceeded 5.2 μm. Since streaks and uneven thickness occurred when electrodes were produced using the compositions obtained in Comparative Example 1 and Comparative Example 3, their coatability was poor, and an electrode for evaluating charge/discharge characteristics could not be obtained.

The total content of zirconium and aluminum in the compositions obtained in Comparative Example 2 and Comparative Example 4 was less than 0.028 parts by weight. The capacity retention rates before and after the 10 C rate discharge were 61.8% and 57.1%, respectively, which were smaller than the values obtained in the examples described below.

The total content of zirconium and aluminum in the compositions obtained in Examples 1 to 4, 6, 8, 12, and 13 was in the range of 0.028 to 0.146 parts by weight, and D₁₀₀ was in the range of 0.2 to 5.2 μm. The coatability of the compositions obtained in Examples 1 to 4, Example 6, Example 8, Example 12, and Example 13 was good. The battery performance was evaluated using the compositions obtained in Examples 1 to 4, Example 6, Example 8, Example 12, and Example 13 as the negative electrode material. As a result, their capacity retention rates before and after the 10 C rate discharge were larger compared with Comparative Examples 1 to 5. In particular, in the compositions obtained through the second pulverization step of Examples 6, 8, 12, and 13, the 0.5 C discharge capacity was high, and the capacity retention rate before and after the 10 C rate discharge was high.

TABLE 9

| | | | | | | | | | | Capacity |
|---|---|---|---|---|---|---|---|---|---|---|
| | | | | | Total | | | | | retention |
| | | | | | amount of | | | 0.5 C | 0.5 C | rate |
| | | | | | zirconium | | | Discharge | Discharge | before and |
| | | | | | and | | | capacity | capacity | after 10C |
| | | | | | aluminum | | | before | after | rate |
| | Metal | Zr | Al | Zr + Al | [parts by | D100 | | 10C rate | 10C rate | discharge |
| | material | [ppm] | [ppm] | [ppm] | weight] | [μm] | Grindometer | [mAh/g] | [mAh/g] | [%] |
| Comp. | Metal | 514 | 346 | 860 | 0.086 | 5.6 | Grains were observed at | 407 | 294 | 72.2 |
| Example 1 | material 1 | | | | | | a position where the | | | |
| | (Ge) | | | | | | groove depth was 50 μm. | | | |
| Comp. | Metal | 65 | 103 | 168 | 0.017 | 2.5 | Streaks were observed | 317 | 196 | 61.8 |
| Example 2 | material 1 | | | | | | from a position where the | | | |
| | (Ge) | | | | | | groove depth was 30 μm. | | | |
| Comp. | Metal | 104 | 146 | 250 | 0.025 | 50.2 | Streaks were observed | 316 | 188 | 59.5 |
| Example 3 | material 1 | | | | | | from a position where the | | | |
| | (Ge) | | | | | | groove depth was 90 μm. | | | |
| Comp. | Metal | 107 | 165 | 272 | 0.027 | 3.6 | Streaks were observed | 835 | 477 | 57.1 |
| Example 4 | material 1 | | | | | | from a position where the | | | |
| | (Ge) | | | | | | groove depth was 30 μm. | | | |
| Comp. | Metal | 1255 | 214 | 1469 | 0.147 | 14.2 | Streaks were observed | 807 | 688 | 85.3 |
| Example 5 | material 1 | | | | | | from a position where the | | | |
| | (Ge) | | | | | | groove depth was 60 μm. | | | |
| Example 1 | Metal | 379 | 195 | 575 | 0.057 | 1.1 | No grains or streaks were | 675 | 453 | 67.1 |
| | material 1 | | | | | | observed from the | | | |
| | (Ge) | | | | | | position where the groove | | | |
| | | | | | | | depth was 100 μm to the | | | |
| | | | | | | | position where the groove | | | |
| | | | | | | | depth was 0 μm. | | | |
| Example 2 | Metal | 202 | 133 | 335 | 0.034 | 5.0 | Streaks were observed | 369 | 275 | 74.5 |
| | material 1 | | | | | | between the position | | | |
| | (Ge) | | | | | | where the groove depth | | | |
| | | | | | | | was less than 50 μm and | | | |
| | | | | | | | a position where the | | | |
| | | | | | | | groove depth was 40 μm. | | | |
| Example 3 | Metal | 267 | 218 | 485 | 0.049 | 2.5 | Streaks were observed | 671 | 444 | 66.2 |
| | material 1 | | | | | | from a position where the | | | |
| | (Ge) | | | | | | groove depth was 10 μm. | | | |
| Example 4 | Metal | 141 | 136 | 277 | 0.028 | 4.5 | Streaks were observed | 954 | 711 | 74.5 |
| | material 1 | | | | | | between the position | | | |
| | (Ge) | | | | | | where the groove depth | | | |
| | | | | | | | was less than 50 μm and | | | |
| | | | | | | | a position where the | | | |
| | | | | | | | groove depth was 40 μm. | | | |
| Example 6 | Metal | 387 | 113 | 500 | 0.050 | 1.1 | No grains or streaks were | 1449 | 1397 | 96.4 |
| | material 2 | | | | | | observed from the | | | |
| | (Ge) | | | | | | position where the groove | | | |
| | | | | | | | depth was 100 μm to the | | | |
| | | | | | | | position where the groove | | | |
| | | | | | | | depth was 0 μm. | | | |
| Example 8 | Metal | 708 | 212 | 920 | 0.092 | 1.3 | No grains or streaks were | 1554 | 1491 | 95.9 |
| | material 2 | | | | | | observed from the | | | |
| | (Ge) | | | | | | position where the groove | | | |
| | | | | | | | depth was 100 μm to the | | | |
| | | | | | | | position where the groove | | | |
| | | | | | | | depth was 0 μm. | | | |
| Example 12 | Metal | 509 | 157 | 665 | 0.067 | 1.3 | No grains or streaks were | 1571 | 1318 | 83.9 |
| | material 2 | | | | | | observed from the | | | |
| | (Ge) | | | | | | position where the groove | | | |
| | | | | | | | depth was 100 μm to the | | | |
| | | | | | | | position where the groove | | | |
| | | | | | | | depth was 0 μm. | | | |
| Example 13 | Metal | 650 | 100 | 750 | 0.075 | 2.2 | No grains or streaks were | 1518 | 1464 | 96.4 |
| | material 2 | | | | | | observed from the | | | |
| | (Ge) | | | | | | position where the groove | | | |
| | | | | | | | depth was 100 μm to the | | | |
| | | | | | | | position where the groove | | | |
| | | | | | | | depth was 0 μm. | | | |

### INDUSTRIAL APPLICABILITY

The metal particles obtained by the method of the present invention can be suitably used as a negative electrode material, for example, for lithium ion secondary batteries and the like.

### DESCRIPTION OF NUMERALS

1: dispersion liquid inlet
2: beads
3: dispersion liquid outlet
4: shaft
5: arm
6: pulverizing container

1. A method for producing a metal particle composition containing particles of a metal material, a component derived from a pulverizing container, and a component derived from beads, the method comprising a step of pulverizing with stirring the metal material containing a metal simple substance having a Mohs hardness of 2.5 to 6.3 in the pulverizing container in the presence of the beads that serve as pulverizing media using a media-stirring type pulverizer equipped with a rotating body,
wherein the mass ratio of the metal material to the beads is 0.02 to 0.10, and
wherein the rotating body has a peripheral speed of 2.5 to 8.5 m/s.

2. The method for producing a metal particle composition according to claim 1, wherein the media-stirring type pulverizer is a media-stirring type mill equipped with a pulverizing container and a stirring blade.

3. The method for producing a metal particle composition according to claim 1, wherein the metal material is at least one germanium material selected from the group consisting of germanium and germanium alloys.

4. The method for producing a metal particle composition according to claim 1, wherein a dispersion medium is used in the step of pulverizing the metal material.

5. The method for producing a metal particle composition according to claim 4, wherein the mass ratio of the metal material to the dispersion medium is 0.07 to 0.5.

6. The method for producing a metal particle composition according to claim 1, wherein the beads have a diameter of 0.03 mm to 2 mm.

7. The method for producing a metal particle composition according to claim 1, wherein the material of the pulverizing container includes alumina, and the material of the beads includes zirconia.

8. The method for producing a metal particle composition according to claim 1, wherein the metal particle composition has a maximum particle diameter (D₁₀₀) of 0.2 to 5.2 μm in a volume-based particle size distribution.

9. The method for producing a metal particle composition according to claim 7, wherein the metal particle composition contains at least one of zirconium and aluminum, and the total amount of zirconium and aluminum is 0.028 to 1.0 parts by weight with respect to 100 parts by weight of the metal particles.

10. A metal particle composition containing metal particles of a metal material containing a metal simple substance having a Mohs hardness of 2.5 to 6.3, and at least one of zirconium and aluminum,
wherein the metal particles have a maximum particle diameter (D₁₀₀) of 0.2 to 5.2 μm in a volume-based particle size distribution, and
wherein the total amount of the zirconium and aluminum is 0.028 to 1.0 parts by weight with respect to 100 parts by weight of the metal particles.

11. The metal particle composition according to claim 10, wherein the total amount of zirconium and aluminum is 0.028 to 0.146 parts by weight with respect to 100 parts by weight of the metal particles.

12. The metal particle composition according to claim 10, wherein the metal material is at least one germanium material selected from the group consisting of germanium and germanium alloys.

13. A metal particle composition obtained by the method according to claim 1.

14. The method for producing a metal particle composition according to claim 3, wherein the material of the pulverizing container includes alumina, and the material of the beads includes zirconia.

15. The method for producing a metal particle composition according to claim 14, wherein the metal particle composition has a maximum particle diameter (D₁₀₀) of 0.2 to 5.2 μm in a volume-based particle size distribution.

16. The method for producing a metal particle composition according to claim 14, wherein the metal particle composition contains at least one of zirconium and aluminum, and the total amount of zirconium and aluminum is 0.028 to 1.0 parts by weight with respect to 100 parts by weight of the metal particles.

17. The metal particle composition according to claim 10, wherein the amount of zirconium is 0.014 to 0.124 parts by weight with respect to 100 parts by weight of the metal particles.

18. The metal particle composition according to claim 10, wherein the amount of aluminum is 0.014 to 0.035 parts by weight with respect to 100 parts by weight of the metal particles.
